(19) United States
(12) Patent Application Publication
(10) Pub. No.: US 2006/0212309 A1
(43) Pub. Date: Sep. 21, 2006

(54) Method for determining the best day of the week for a recipient to receive a mail piece

(75) Inventors: John H. Winkelman, Southbury, CT (US); John W. Rojas, Norwalk, CT (US); Kenneth G. Miller, Bethel, CT (US); Alla Tsipenyuk, Woodbridge, CT (US); James R. Norris JR., Danbury, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 11/373,479

(22) Filed: Mar. 10, 2006

Related U.S. Application Data
(60) Provisional application No. 60/663,027, filed on Mar. 18, 2005.

(51) Int. Cl. G06F 17/00; G06Q 99/00

(52) U.S. Cl. 705/1; 705/404

(57) ABSTRACT

A computer method that determines the best day of the week for a recipient to receive a mail piece that is part of a mailing campaign. The method includes by applying a unique code to each mail piece in the mailing; tracking the mail piece to determine when the mail piece is received by a recipient; correlating the recipient's response to information contained in the mail piece with the day of the week when the mail piece is delivered to the recipient.

### CROSS REFERENCE TO RELATED APPLICATIONS

This Application claims the benefit of the filing date of U.S. Provisional Application Number 60/663,027 filed Mar. 18, 2005, which is owned by the assignee of the present Application.

Reference is made to commonly assigned co-pending patent application Docket No. F-986-O1 filed herewith entitled “Method For Predicting When Mail Is Received By A Recipient” in the names of John W. Rojas, John H. Winkelman, Kenneth G. Miller, Alla Tsipenyuk and James R. Norris, Jr. Docket No. F-986-O2 filed herewith entitled “Method for controlling When Mail Is Received By A Recipient” in the names of James R. Norris, Jr., John H. Winkelman, Kenneth G. Miller, John W. Rojas and Alla Tsipenyuk. Docket No. F-986-O3 filed herewith entitled “Method For Predicting Call Center Volumes” in the names of Kenneth G. Miller, John H. Winkleman, John W. Rojas, Alla Tsipenyuk and James R. Norris, Jr. Docket No. F-986-O4 filed herewith entitled, “Method for Dynamically Controlling Call Center Volumes,” in the names of Alla Tsipenyuk, John H. Winkleman, John W. Rojas, Kenneth G. Miller and James R. Norris, Jr.

### FIELD OF THE INVENTION

This invention relates to mailing mail pieces and, more specifically, to database marketing to determine how to have mail (also referred to as “direct marketing mail”) into the homes of prospects on specific days of the week or on specific dates.

### BACKGROUND OF THE INVENTION

Direct mail marketers have faced increasing challenges in maintaining response rates to their marketing programs. There are certain variables that have been historically controllable such as the creation of the mail piece and the information or offer contained therein, and incentive for the mail piece itself. The direct mail marketer has not been able to reasonably measure the sensitivity to the day of week that the prospective customer receives the mail piece, nor been able, in any reasonable way to control when the prospect actually receives the standard ‘A’ mail piece.

Establishing in home date sensitivity provides the direct mail marketer a critical new capability—The ability to understand prospect population behavior around mail open-ability; that is there are certain days of the week when direct mail is simply more likely to be discarded and other days of the week when the prospect population is more likely to open the mail, increasing the propensity of the prospective customer to act on the offer.

Maximizing direct mail response rates has historically been a process of manipulating the offer (the price), the incentive (for example a free label maker) and the creative components (the format of the envelope as well as the contents) of the mail piece as well as selecting the prospect population by selecting mailing lists. Determining the best day of the week for the recipient to get the mail piece has, however, been problematic. Current state of the art uses a process referred to as seeding which allows the marketer to determine when a population may be receiving the offer by sending mail pieces to third parties across the country who then date stamp the mail piece and send them back to the marketing department, from there the marketer can infer roughly when the prospect population received the mail piece.

Currently direct mail marketers determine the best day of the week to get mail pieces to prospects using seeds. Seeding involves sending a mail piece to a known address of a service firm and having the firm date stamp the mail piece and send it back to the direct mail marketer. A large number of seeds would be 200 or so. The direct mail marketer then infers the in-home dates for the mailing as a whole by correlating the shipment date of the mail (when it leaves the letter shop) and when the seed indicated that they received the mail piece. The direct mail marketer then assumes that all mail going to the area that the seed is in arrives on the same day.

Another disadvantage of the prior art is that direct mail marketer's are not able to know or control when the mail will be delivered to a recipient.

Another disadvantage of the prior art is that there are 38,000 or so post offices in the United States. The post offices are not consistent in the time that they take to process and deliver bulk mail. As such the number of seeds is vastly smaller than the number of post offices processing and delivering mail so the direct mail marketer has to make a vast number of assumptions as to when the prospect is receiving the mail piece.

Additionally, many direct mail marketers have tried to establish when prospects are receiving their mail by tracking the dates when order responses are peaking and attempting to figure out when the prospect received the offer via surveys. The foregoing process is not very reliable.

A further disadvantage of the prior art is that direct mail marketers are unable to measure the elapsed time between when the prospect receives the mail piece and when the prospect acts on the offer. The time may be anywhere from immediately to a week later. Thus, the marketers have difficulty staffing call centers and fulfillment operations. Hence, more people may be hired when they are not needed, or there are not enough people to handle all the orders and, consequently, business is lost.

### SUMMARY OF THE INVENTION

This invention overcomes the disadvantages of the prior art by determining when the prospect receives the offer; determining the day of week or day of month that produces the highest response rate; and determining prospect behavior in terms of gap between receiving the offer and acting on it.

Correlating the order responders to the in-home date that the mail is delivered to the recipient's home or place of business via a database allows the marketer to measure the number of orders per thousand mail pieces and subsequently rank the days of the week producing the maximum number of orders. The database correlation may include mail responses, phone responses, fax responses and Internet based responses.

The foregoing is accomplished by applying a unique code to each mail piece in the mailing; tracking the mail piece to determine when the mail piece is received by a recipient; correlating the recipient's response to information contained in the mail piece with the day of the week when the mail piece is delivered to the recipient.

### BRIEF DESCRIPTION OF THE DRAWINGS

FIG. 1 is a flow chart of a prior art direct mail marketing process;

FIG. 2 is a flow chart showing how to predict recipient delivery distribution for a mailing;

FIG. 3 is a table showing the results of date sensitive analysis for some mailing campaigns delivered during the summer of 2005.

FIG. 4 is a flow chart showing how to determine the in-home date for a mail piece.

### DETAILED DESCRIPTION OF THE INVENTION

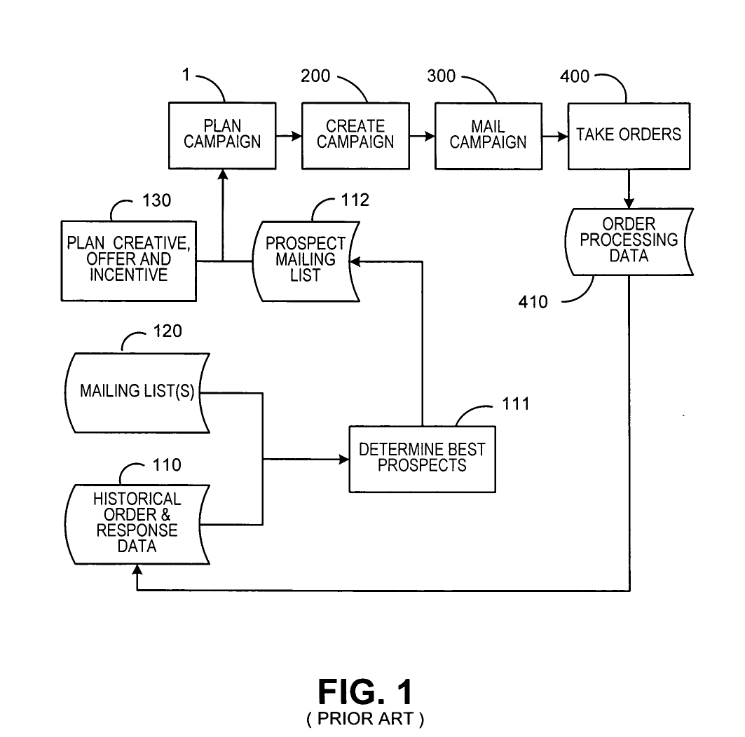

Referring now to the drawings in detail and, more particularly, to Prior Art FIG. 1, the process begins in step 1, where the direct mail marketer plans the campaign. Inputs into campaign planning include planning the creative, i.e., the design of the mail piece, offer and incentive in step 130 and acquiring mailing lists in step 120; then selecting prospects in step 112 by comparing respondent profiles in step 111 from different marketing tests, i.e., previous campaigns in step 110. Once the marketer has created the artwork, selected the prospects to be mailed from the lists available, the campaign is actually created in step 200. Step 200 involves having the various components of the mailing campaign printed, assembled and printing the addresses on the mail pieces and the address presorted. From there, the direct mail marketer mails, i.e., drop ships the mail to the appropriate USPS facility, the offer to all prospective customers in step 300. Once the prospective customers receive the offer, some prospects place orders in step 400. When the prospect orders, the direct mail marketer captures order processing data in step 410 and correlates the data with demographic information. That data is fed back into the order history database in step 110 and used to profile prospective customers for upcoming campaigns.

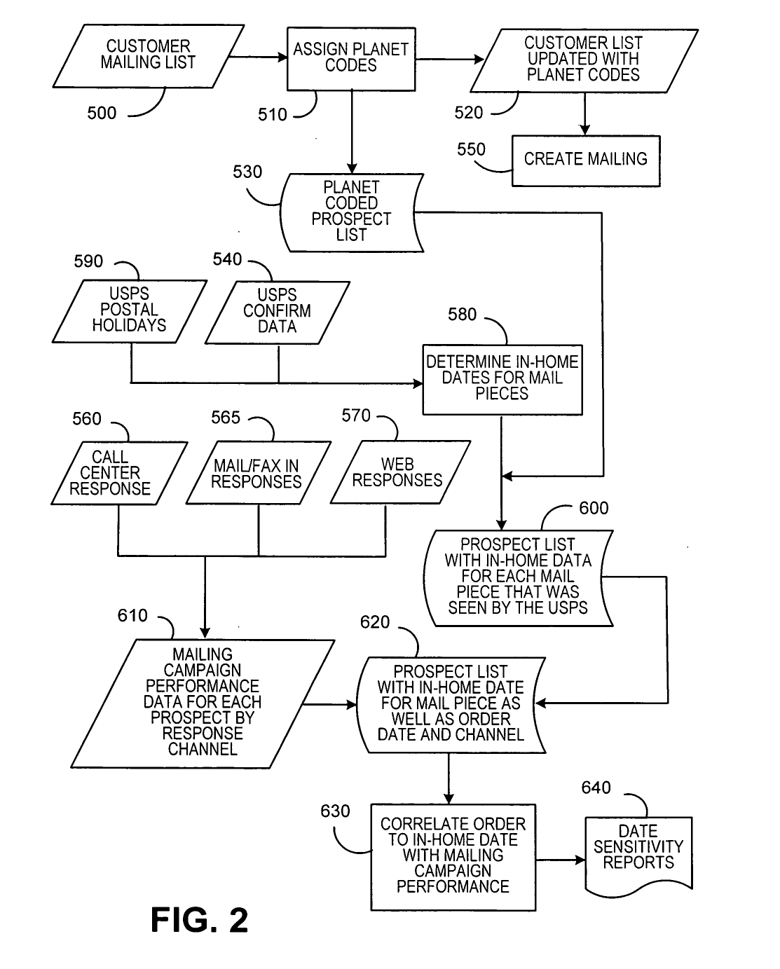

In FIG. 2, the process starts with the customer providing a mailing list containing at least two pieces of data the delivery point code (zip+4+2) and a unique identifier for each prospect in the customer mailing list of step 500. The system takes the address list obtained in step 500 and assigns a unique destination planet code to each prospect in the file in step 510. Optionally, the system may assign a unique original planet code to each prospect in the file. The updated file or database is then returned to the customer in step 520 who creates the mailing, by applying the destination bar codes to the outside of the envelope and the origin bar codes to the return mail pieces in step 550. The planet coded and prospect list is produced and stored in step 530 in order to track and correlate responses associated with actual in-home results.

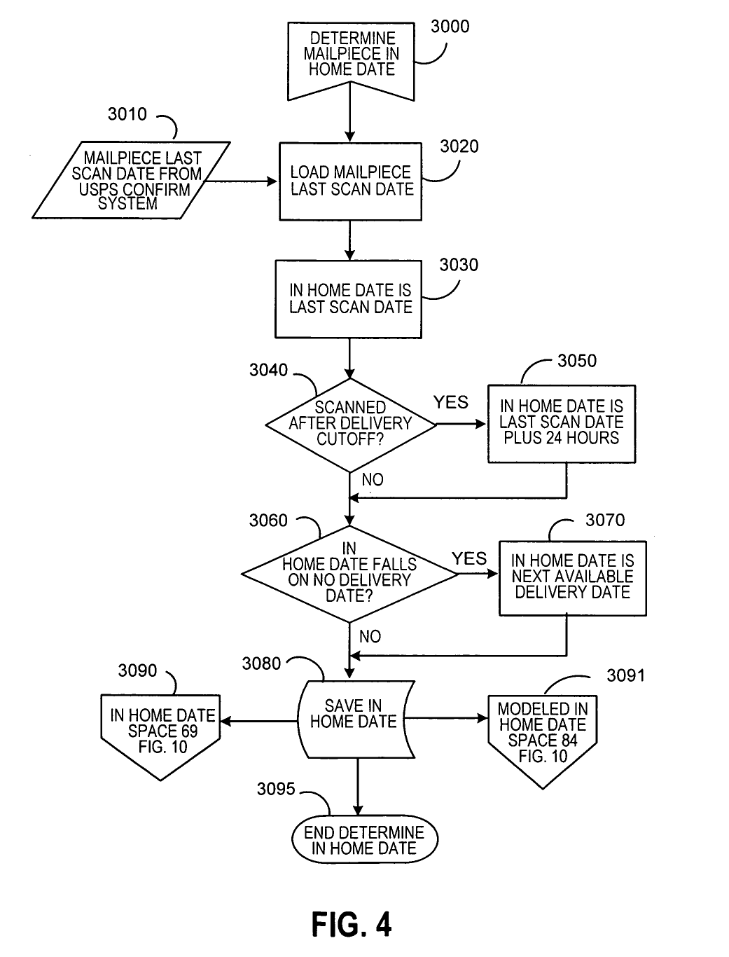

The destination bar code is used on the outbound mail piece and is scanned by equipment in the postal infrastructure and data is returned through confirm to the tracking system in step 540. In step 580 the system correlates the tracking data to the prospect list determining when the prospect receives the mail piece by correlating the scan data in step 540 with each prospect mail piece as well as adjusting for Sundays and postal holidays when mail is not delivered in step 590. Step 580 is described in more detail in the description of FIG. 4. The correlated list in step 600 is then updated in step 620 as prospects or prospective customers call with orders (step 560), mail orders (step 565) or orders through the Internet in step 570 as well as responses from other channels or in person which are collected as mailing campaign performance data in step 610. From there the system establishes the best day of the week for the prospect to receive the mail piece by counting the number of mail pieces in-homed on a given day and measuring the results of different performance resulting from prospect responses for those mail pieces arriving on a given day of the week or date within a given month using date sensitive analytics in step 630. A report is output in step 640 with the number of mail pieces arriving in-home on any given day or date, the number of orders resulting from mail arriving on that day or date and the number of orders per thousand mail pieces (order rate) for that mail. Optionally, the system may output reports based upon response channel or some combination of demographics. Once the direct mail marketer has the data, it is possible to determine if the given exhibits date sensitivity, the extent of the sensitivity and who, based upon demographic data, is most likely to respond to a given offer arriving on a certain day or days.

The above flow chart may be expanded to correlate and track responses by prospect type, geographic location, seasonality, weather, age, occupation, race, sex, etc. in order to track best day of the week for the above categories.

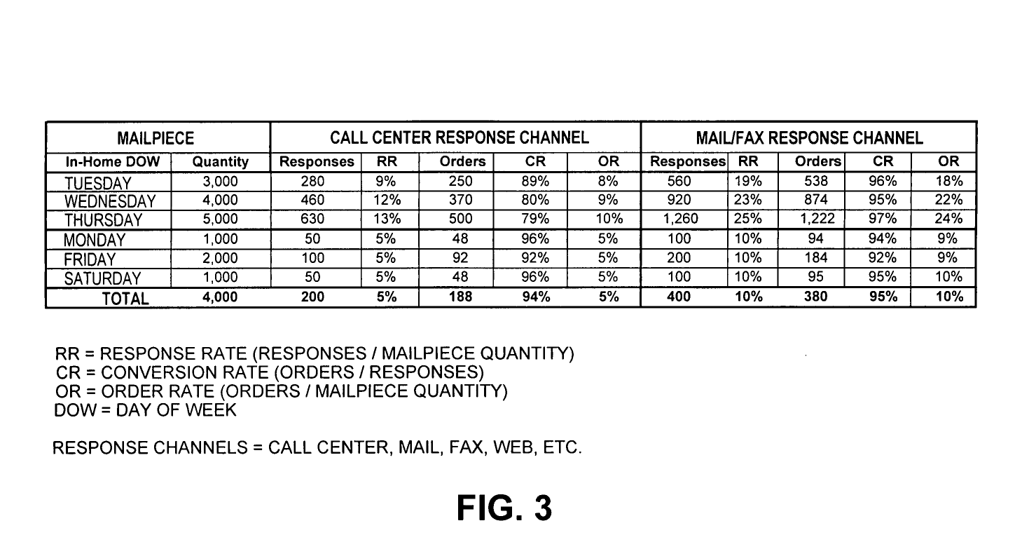

FIG. 3 depicts a table showing the results of date sensitive analysis for mailing campaigns delivered in the summer of 2005. The rows show the results for different days of the week. The columns on the right are divided into sections: analysis results for Call Center responses and analysis results for Mail/Fax responses.

The columns in each section (calls and mail/fax) show the total quantity of mail delivered on each day during the evaluation period, the total responses for each day, the measured response rate (RR) for each day, the total orders placed for mail arriving on each day, the Conversion rate (CR) of responses to orders, and the order rate (OR) for each day.

The analysis shows that the best days are Thursday, Wednesday and Tuesday, because they have the highest response and order rate for both the call center and mail/fax channels. In this case, a recommendation would be made to the call center to add more staff during Thursday, Wednesday and Tuesday in order to handle the added call volume and further increase the conversion and order rates.

The above analysis was performed for the offering of a specific product. It would be obvious to one skilled in the art that offerings for different products will have results different from the above.

FIG. 4 is a flowchart indicating how the In Home Date is calculated for a mail piece, and saved in space 69, IN_HOME_DATE, in FIG. 10D and is also used to calculate MODELED_IN_HOME_DATE in space 84 in FIG. 10F.

The process is applied to each mail piece that is scanned and starts in step 3000 and is followed by step 3020, where the last scan for the mail piece is loaded from step 3010, Mail piece Last Scan Date from USPS Confirm System. Next, step 3030 initializes the In Home Date for the mail piece as the Last Scan Date and then if step 3040 determines if the mail piece scan occurred after the delivery cut-off time for that facility, step 3050 will add 24 hours to the in home date, since the mail piece will not be delivered on the same day. Next if step 3060 determines that the In Home Date falls on a no-delivery date, such as a Sunday, Holiday, or exception date, etc, step 3070 will use the next available delivery date is used as the In Home Date for the mail piece.

It should be understood that although the present invention was described with respect to mail processing by the USPS, the present invention is not so limited and can be utilized in any application in which mail is processed by any carrier. The present invention may also be utilized for mail other than direct marketing mail, for instance, transactional mail, i.e., bills, charitable solicitations, political solicitations, catalogues etc. Also the expression “in-home” refers to the recipient's residence or place of business.

The above specification describes a new and improved method for determining the best day of the week for a recipient to receive a mail piece. It is realized that the above description may indicate to those skilled in the art additional ways in which the principles of this invention may be used without departing from the spirit. Therefore, it is intended that this invention be limited only by the scope of the appended claims.

What is claimed is:

1. A method utilizing a computer to determine the day of the week that produces the highest response rate to information contained in a mail piece that is part of a mailing campaigns for a range of dates comprising the steps of:
applying a unique code to each mail piece in the mailing campaign; determining when the mail piece is received by a recipient; and
correlating the recipient's response to information contained in the mail piece with the day of the week when the mail piece is delivered to the recipient.

2. The method claimed in claim 1, wherein the correlating step further comprises the steps of:
measuring orders received by the mailer; and
ranking the days of the week producing the maximum number of orders.

3. The method claimed in claim 1, wherein the correlating step further comprises the steps of:
measuring order rate for the mailing; and
ranking the days of the week producing the maximum order rate.

4. The method claimed in claim 1, wherein the correlating step further comprises the steps of:
measuring conversion rate for the mailing; and
ranking the days of the week producing the maximum conversion rate.

5. The method claimed in claim 1, wherein the correlating step further comprises the steps of:
measuring response rate for the mailing; and
ranking the days of the week producing the maximum response rate.

6. The method claimed in claim 1, further including the step of:
measuring a gap between the recipient's receipt of the information contained in the mail piece and the recipient's acting on the information.

7. The method claimed in claim 1, wherein the information is a offer for goods or services.

9. The method claimed in claim 1, wherein the response rate is the number of orders received.

10. The method claimed in claim 1, wherein the response rate is the number of responses that become orders.

11. The method claimed in claim 1, wherein the recipient's response is by facsimile, physical mail, telephone, in person, and e-mail.

12. The method claimed in claim 1, wherein the determining step further includes the step of tracking the mail piece.

13. The method claimed in claim 1, wherein the determining step further includes the step of predicting the in-home date of the mail piece.
